(19) United States
(12) Patent Application Publication
(10) Pub. No.: US 2006/0286535 A1
(43) Pub. Date: Dec. 21, 2006

(54) Educational systems and methods

(76) Inventor: Iline du Toit, Lyttelton Centurion (ZA)

Correspondence Address: HARNESS, DICKEY, & PIERCE, P.L.C, 7700 BONHOMME, STE 400, ST. LOUIS, MO, 63105, US

(21) Appl. No.: 11/334,517

(22) Filed: Jan. 18, 2006

(30) Foreign Application Priority Data
May 27, 2005 (ZA) 2005/04352

(51) Int. Cl. G09B 3/00

(52) U.S. Cl. 434/350

(57) ABSTRACT

Systems and methods are provided for educational content delivery and learning. In one exemplary embodiment a system generally includes an educational matter including organized content addressing an educational topic. The system also includes audio visual medium including one or more presentations having content generally associated with the educational matter content and generally coordinated, at least in part, with the organization of the educational matter content.

### CROSS-REFERENCE TO RELATED APPLICATION

This application claims the benefit of South African filed Provisional Application No. 2005/04352, filed on May 27, 2005, and entitled Educational Material. The disclosure of the above application is incorporated herein by reference.

### FIELD

The present invention relates to systems and methods for delivering educational demonstration material and content to a student, acquiring educational content by a student, and for providing an educational kit to be offered to students and a method of learning therefrom.

### BACKGROUND OF THE INVENTION

The statements in this section merely provide background information related to the present disclosure and may not constitute prior art.

It is generally understood that the educational experience and success of a school or other educational institution is based, at least in part, on the effectiveness with which the educational material is conveyed or presented to the students. Traditional schools or educational programs typically require the student to enroll in a class, purchase a text book at a book store or on-line, and attend the class to view a series of presentations given by an instructor. Some programs include the ability for the presentations to be shared with remote classrooms, or to be stored, and later shown to another class or at another classroom. Additionally, with computer and Internet technologies, interactive educational programs have become increasingly available. Some of these include websites that provide for the displaying of presentations given by an instructor as well as graphical presentations in support of the program.

As recognized by the inventor hereof, the current systems and methods do not provide efficient and effective systems or methods that enable a student to receive a similar educational experience remote from the classroom as the student would have received had the student attended the class and listened to the presentations associated with the text book. Additionally, the current systems and methods do not provide the flexibility to enable a student to view lectures away from the class room environment as may be required where a student needs additional review or is not able to attend the class.

### SUMMARY

The inventor hereof has succeeded at designing systems and methods for delivering an educational program to a student, the educational program offering an enhanced educational learning experience to a student while providing the student with improved flexibility in receiving such a learning experience.

According to one aspect, a system for educational content delivery includes educational matter having text and organized content addressing an educational topic and an audio visual medium including one or more presentations having content generally associated with the educational matter content and generally coordinated, at least in part, with the organization of the educational matter content.

According to another aspect, a method of delivering educational content to a student includes offering a course having educational content, registering a student for the offered course and delivering to the registered student educational matter including the educational content in an organized format. The method also includes delivering to the registered student an audio visual medium having one or more presentations with content generally associated with the educational content and generally coordinated, at least in part, with the organized format of the educational content. The delivering of the audio visual presentation medium is done in conjunction with the receiving the registration.

According to another aspect, a method of acquiring educational content by a student includes registering with an educational institution for a course having educational content and receiving educational matter including the educational content in an organized format from the educational institution. The method also includes receiving an audio visual medium having a plurality of presentations with content generally associated with the educational content and generally coordinated, at least in part, with the organized format of the educational content. The method further includes reviewing the educational matter and displaying the presentations contained on the audio visual medium.

According to yet another aspect, a method of providing an educational kit to be offered to students by an educational institution as a course includes preparing educational matter having educational content and recording one or more presentations associated with the educational matter. The method also includes preparing an audio visual medium having the presentations.

According to still another aspect, a method of learning includes receiving educational matter having educational content from an educational institution; receiving an audio visual medium having lectures associated with the educational content from the educational institution, reviewing the educational matter, and displaying the lectures stored on the audio visual medium in lieu of attending classroom held lectures or as a supplemental educational aid to the classroom held lectures.

Further aspects of the disclosure will be in part apparent and in part pointed out below. It should be understood that various aspects of the disclosure may be implemented individually or in combination with one another. It should also be understood that the detailed description and drawings, while indicating certain exemplary embodiments of the invention, are intended for purposes of illustration only and should not be construed as limiting the scope of the disclosure or the embodiments of the invention.

### BRIEF DESCRIPTION OF THE DRAWINGS

The drawings described herein are for illustration purposes only and are not intended to limit the scope of the present disclosure in any way.

FIG. 1 is an educational content delivery system according to one exemplary embodiment of the invention.

FIG. 2 is an educational content delivery system according to other various exemplary embodiments of the invention.

FIG. 3 is a block diagram of a computer system that may be used to implement a method and apparatus embodying some aspects of the invention.

FIG. 4 is a flow chart of a method for delivering educational content to a student according to another exemplary embodiment of the invention.

FIG. 5 is a flow chart of a method for providing an educational kit to be offered to students by an educational institution as a course according to another exemplary embodiment of the invention.

FIG. 6 is a flow chart of a method of learning according to still another exemplary embodiment of the invention.

Like reference symbols indicate like elements or features throughout the drawings.

### DETAILED DESCRIPTION

The following description is merely exemplary in nature and is not intended to limit the invention, its applications, or uses.

In one embodiment, an educational content delivery system includes educational matter and an audio visual medium. The educational matter includes organized content addressing an educational topic, such as a topic of a course to be taken by a student. The audio visual medium includes one or more presentations, often a plurality, having content generally associated with the educational matter content and generally coordinated, at least in part, with the organization of the educational matter content.

As described herein, such an educational content delivery system enables an educational institution to provide an educational experience to a student who may be remote from the educational facility, and therefore provides for delivery of the educational experience without having to provide the student with a classroom seat. Such a system also enables a student to obtain a full educational experience without having to attend classes or lectures, thereby providing the student with increased flexibility and the availability of time and location, which is a significant benefit to students who cannot attend lectures associated with an offered course. Additionally, such systems and methods can be utilized by students as a supplemental aid to classroom held lectures. For example, a student may be unable to attend a lecture, or may require to review a previously held and/or viewed lecture. Such educational content delivery system may also advantageously be used by educational institutions to supplement the educational experience of students who attend classes or lectures.

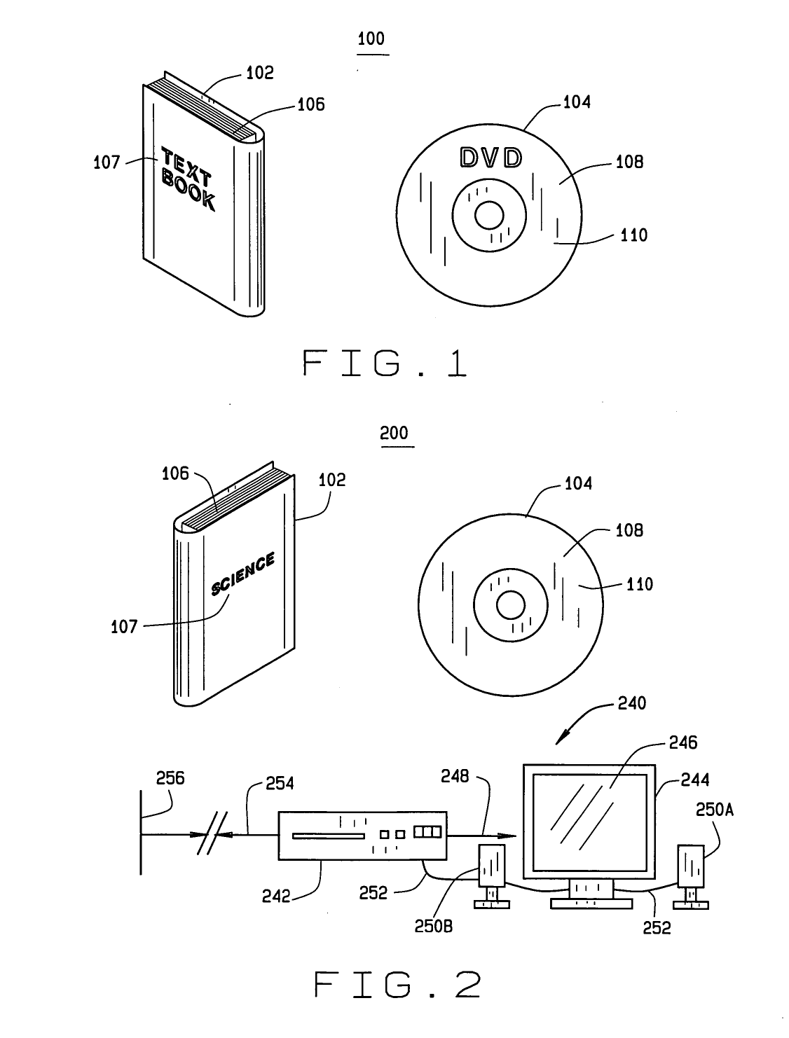

FIG. 1 illustrates one exemplary embodiment of an educational content delivery system 100. It should be noted that one embodiment of the educational content delivery system 100 may be a kit comprising one or more of the elements illustrated by system 100. As shown in system 100, educational matter 102 is illustrated as a text book. While not illustrated in FIG. 1, the educational matter 102 includes content 106 that is organized for the presentation of an educational topic 107. Typically, the educational topic 107 can include any topic that a student or other person would wish to learn and often would be required to attend course lectures or presentations of an instructor, teacher, or professor, such as at a school or university. Often, the educational matter 102 can be presented in a text format with illustrations and can be the educational matter 102, which is shown by way of example as a book, or any other medium for storing a delivery organized educational content 106 such as a magazine, a newspaper, loose leaf pages, and a web page.

An audio visual medium 104 is shown, by way of example as a digital video disc (DVD). In other embodiments not shown, the audio visual medium 104 can be one or more storage medium such as a video disk, a tape, a thumb-drive, a memory stick, and/or a webpage address and login authorization. The audio visual medium 104 can include audio visual content 108 such as one or more presentations 110 that includes content generally associated with the educational matter content 106 and generally coordinated, at least in part, with the organization of the educational matter content 106. For example, in one embodiment, the presentations 110 are included with the audio visual medium 104 that relate to the presentations given by a presenter, such as a well-known expert or leading instructor on the subject matter or a related topic, as would be given during an offered course at a school or university. Typically, this can include visual demonstrations such as images of a presentation along with coordinated audio. The audio visual medium 104 can have a prerecorded image or sequence of images with audio including a tour, a demonstration, a text, a graph, a chart, an experiment, an example, an outline, an interview, a mockup, a model, a play, a staged act, by way of example.

In some embodiments, the educational matter 102 and the audio visual medium 104 of the system 100 together include the course content about equivalent to the content of an educational course offered by an educational institution traditionally requiring a student to attend lectures to obtain the same course content. The audio visual medium 104 is configured to be delivered to a student in conjunction with the delivery of the educational matter 102. For example, in one embodiment, the audio visual medium 104 and the educational matter 102 are each configured to be delivered to a student in conjunction with registration of the student for a course addressing the content of the educational matter.

The system 100 can provide for delivering an educational course typically offered by a school or university and that typically requires the student to attend classes to hear and see the lecture presented by a teacher or lecturer. In this manner, the system 100 or other embodiments of the invention, can provide a more flexible and potentially less costly system for delivering educational content and material and the educational experience to the student.

In some embodiments, the system 100 can also include a study guide, a study plan, a course outline, and/or course instructions, each of which can be used by the student along with the audio visual medium 104 and the educational matter 102. Such additional educational aids can also be provided to the student at the time of registration.

As shown in FIG. 2, in other embodiments, the system 200 includes educational matter 102, audio visual medium 104, and audio visual presentation device 240. The audio visual presentation device 240 is configured to extract and present the audio video content from the audio visual medium 104, e.g., displays images and playing sounds associated with the presentations to the student. As shown in this example, the audio visual presentation device 240 can include a DVD player 242 and a display 244 having a viewable display screen 246 that is coupled via a display communication link 248. Additionally, one or more audio reproduction devices or speakers, shown as two speakers 250A and 250B, may also be coupled to the DVD player 242 for reproducing audio content stored on the audio visual medium. The audio visual presentation device 240 can include, by way of example, a computer, a disk player, a tape player, a personal media player, a television, a personal data assistant, and a mobile phone with a display.

The audio visual presentation device 240 can include a communication interface 254 that is configured for communication over a communication network 256 so that some or all of the audio visual content 108 stored on the audio visual medium 104 is communicated to the audio visual presentation device 240 over the communication interface 254.

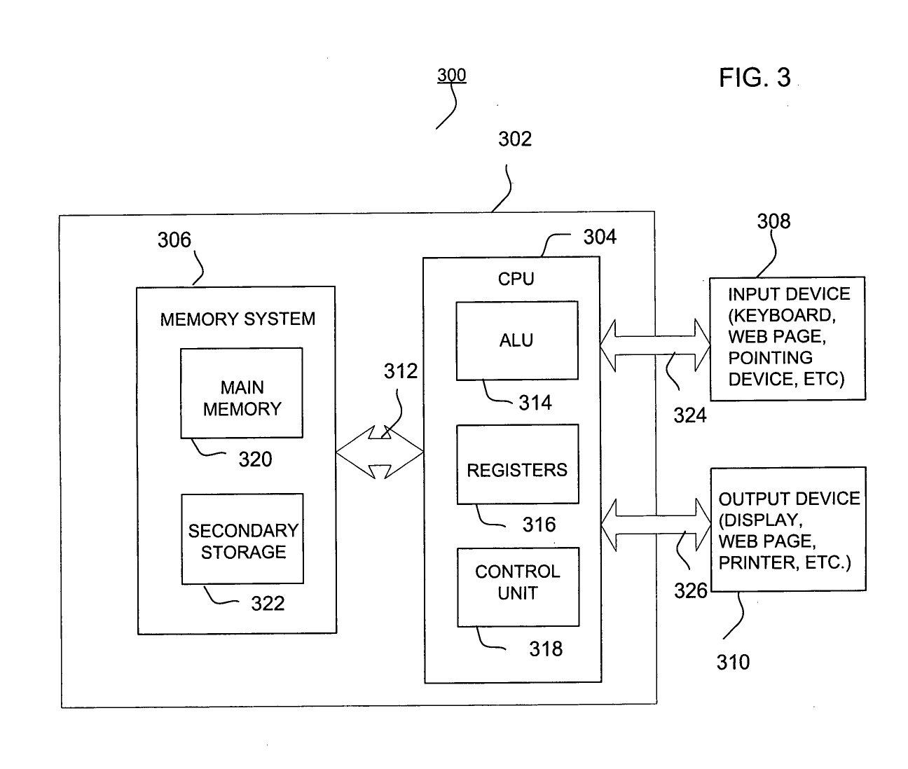

Various embodiments of the invention can be implemented via a computer-aided system. As shown in FIG. 3, a computer operating environment for one exemplary embodiment of the invention is a computer system 300 with a computer 302 that comprises at least one processing unit (CPU) 304, in conjunction with a memory system 306, an input device 308, and an output device 310. These elements are interconnected by at least one bus structure 312.

The illustrated CPU 304 is of familiar design and includes an arithmetic logic unit (ALU) 314 for performing computations, a collection of registers 316 for temporary storage of data and instructions, and a control unit 318 for controlling operation of the computer system 300. Any of a variety of processors, including at least those from Digital Equipment, Sun, MIPS, Motorola, NEC, Intel, Cyrix, AMD, HP, and Negev, are equally preferred for the CPU 304. The illustrated embodiment of the invention operates on an operating system designed to be portable to any of these processing platforms.

The memory system 306 generally includes a main memory 320 in the form of a medium such as random access memory (RAM) and read only memory (ROM) semiconductor devices, and secondary storage 322 in the form of long term storage mediums such as floppy disks, hard disks, tape, CD-ROM, flash memory, etc. and other devices that store data using electrical, magnetic, optical or other recording media. The main memory 320 also can include video display memory for displaying images through a display device. Those skilled in the art will recognize that the memory system 306 can comprise a variety of alternative components having a variety of storage capacities.

The input and output devices 308 and 310, respectively, are also familiar. The input device 308 can interface to the computer 302 via an input interface 324 that can be any type of suitable interface. The input device 308 can comprise a keyboard, a mouse, a physical transducer (e.g. a microphone), etc. The output device 310 can interface to the computer 302 via an output interface 326 that can be any type of wired or wireless interface. The output device 310 can comprise a display, a printer, a transducer (e.g. a speaker), etc. Some devices, such as a network adapter or a modem, can be used as input and/or output devices.

As is familiar to those skilled in the art, the computer system 300 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 306.

In accordance with practices of persons skilled in the art of computer systems and programming, some embodiments of the invention can be implemented as described herein with reference to symbolic representations of operations that are performed by the computer system 300. Such operations are sometimes referred to as being computer-executed. It will be appreciated that the operations which are symbolically represented include the manipulation by the CPU 304 of electrical signals representing data bits and the maintenance of data bits at memory locations in the memory system 306, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 306. The computer system 300 can be configured to perform one or more processes associated with the methods herein described.

Another embodiment of the invention is a method of delivering educational content to a student and can include the acquisition of the educational content by the student. The method includes offering a course having educational content, registering a student for the offered course, delivering to the registered student educational matter including the educational content in an organized format, and delivering to the registered student an audio visual medium having one or more presentations with content generally associated with the educational content and generally coordinated, at least in part, with the organized format of the educational content.

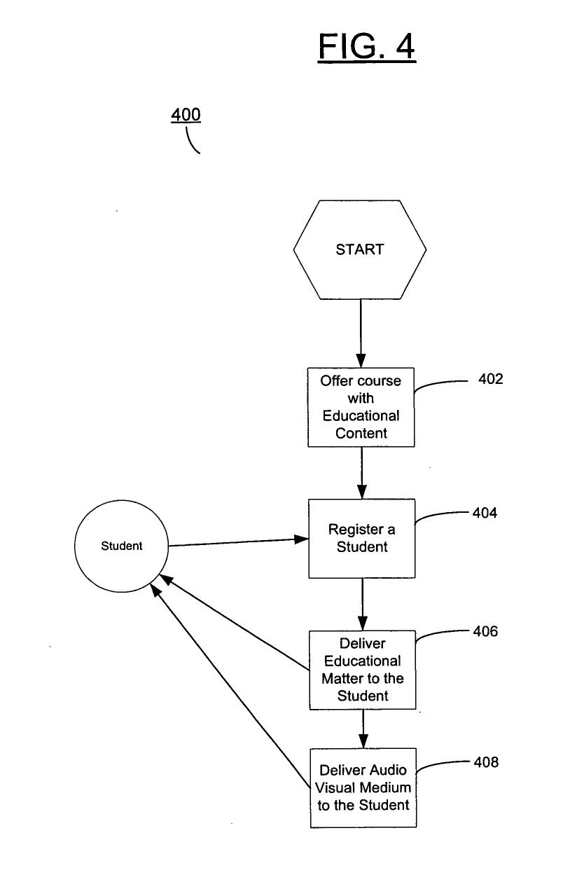

Referring now to FIG. 4, one exemplary method 400 for delivering educational content is illustrated in a flow chart format. The method 400 starts with the offering of a course in 402 having educational content. The offered course may have any educational course content. In some embodiments, the offered course is identified as a course not requiring the student to attend a traditional classroom to receive the required educational content. In 404, a student is registered for the offered course. This registration may be in person, by mail or on-line. Generally, it is in response to the student reviewing the offered course and its content, and requesting to be registered for the particular course. In 406, the educational matter including the educational content in an organized format is delivered to the registered student. An audio visual medium having one or more presentations generally associated and coordinated with the educational content is delivered in 408 to the registered student and received by him. In some embodiments, the registered student receives the educational matter from the offering educational institution at the time of the registering, receiving the audio visual medium. The student can then review the educational matter and display the video and play the audio associated with the presentations stored on the audio visual medium.

In some other embodiments, a sequence of prerecorded images such as those associated with a tour, such as a museum tour may be included. In other embodiments, a demonstration, text such as slides, a graph or chart, an experiment, an example, an outline, an interview, a mockup, a model, a play, or a staged act may be included in the sequence of prerecorded images.

Another embodiment of the invention is a method of acquiring educational content by a student. The method includes the student registering with an educational institution for a course having educational content. The student receives educational matter including the educational content in an organized format from the educational institution, which may be at the time or coincidental with registering, or later. The method also includes the student receiving an audio visual medium having a plurality of presentations with content generally associated with the educational content and generally coordinated, at least in part, with the organized format of the educational content. This again may be at the time of registering or later. The method further includes reviewing the educational matter and displaying the presentations contained on the audio visual medium.

Another embodiment of the invention is a method of providing an educational kit to be offered to students by an educational institution as a course. Such a method includes preparing educational matter having educational content, recording one or more presentations associated with the educational matter, and preparing an audio visual medium having the presentations.

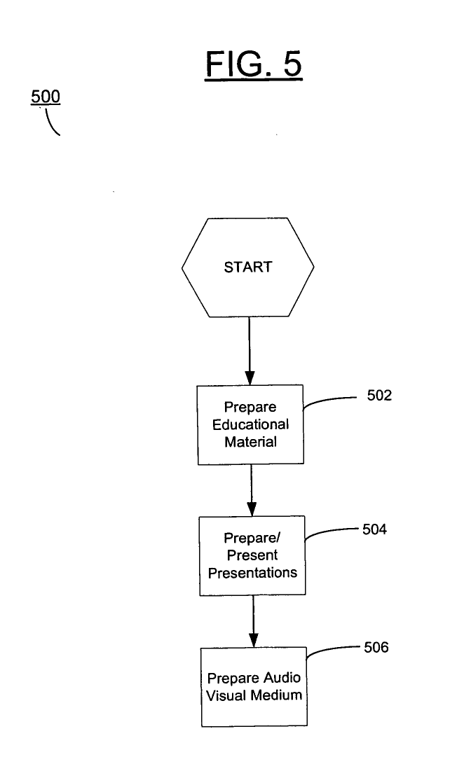

One exemplary embodiment of a method 500 for providing an educational kit is illustrated in FIG. 5. The method 500 starts with preparing educational matter having educational content in 502, and continues with the recording of one or more presentations in 504 that are associated with the educational matter. This can include the preparation of the presentation or lecture based, at least in part, on the educational matter, or a sub-portion thereof, by a lecturer, teacher, or expert in the subject matter. It can also include, in some embodiments, a tour, a video or other sequence of images, a graph, or other supporting image and/or audio, that can support the presentation of the presenter.

Preparing the education matter in 502 can also include preparing content and an organization for the content for any educational topic to be offered and which is desired by a student or other person who would want to learn about the topic and typically would be required to attend course lectures or presentations of an instructor, teacher, or professor, such as at a school or university. Often, the educational matter can be presented in a text format with illustrations and can be the book, which is shown by way of example, or any other medium for storing a delivery of organized educational content including printed educational material such as a magazine, a newspaper, loose leaf pages, and a web page. In some embodiments, the method 500 process of preparing the educational matter in 502 can include producing printed educational material. As noted, such printing can include publishing in hard format or making electronic content available over a network such as the Internet.

The method 500 also includes preparing an audio visual medium in 506 having the presentations. This can include preparing a prerecorded image that can include images including a tour, a demonstration, text, a graph, a chart, an experiment, an example, an outline, an interview, a mockup, a model, a play, and/or a staged act. This can also include capturing the audio and/or the images such as through a recording, editing the images, creating supporting text or graphic images and/or bylines, narrating the images or presentation, producing a final version, and storing a copy on an audio visual medium, such as described above. Preparing an audio visual medium in 506 can, in some embodiments, include digitizing the images and audio and storing such digitized data on a server or memory device that may be accessible by a network. In some embodiments, the method can also include preparing the audio visual medium such as a digital video disk (DVD), a video disk, a tape, a thumb-drive, a memory stick, and/or a webpage, that can be made available to a student either in hard form or accessible through a network.

The educational matter and the audio visual medium can be prepared by a supplier of educational material who, after preparation, delivers the educational matter and the audio visual medium to an educational institution such as a school or university.

In another embodiment of the invention, a method of learning includes receiving educational matter having educational content from an educational institution, receiving an audio visual medium including lectures associated with the educational content from the educational institution, reviewing the educational matter, and displaying the lectures stored on the audio visual medium in lieu of attending classroom held lectures.

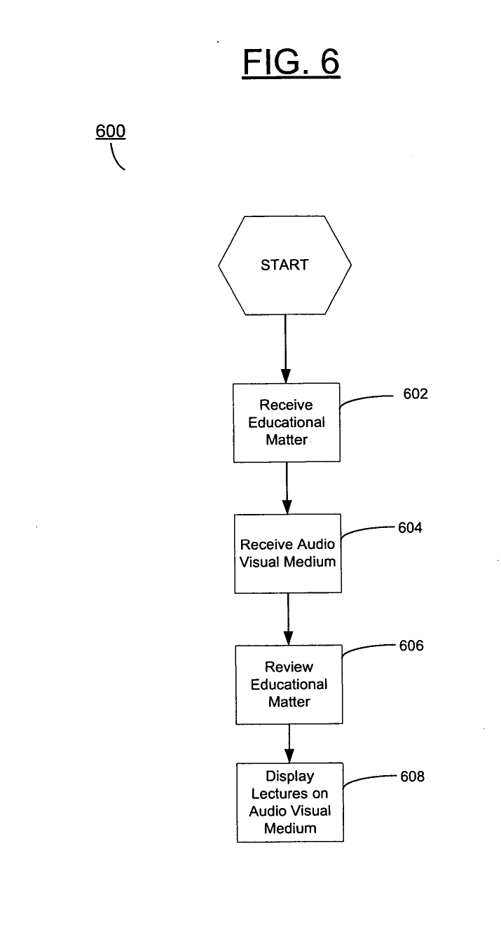

One exemplary embodiment for a method of learning 600 is illustrated in FIG. 6. The method 600 starts with receiving educational matter in 602 that includes educational content from an educational institution, and continues with the receiving an audio visual medium having lectures associated with the educational content from the educational institution in 604. The receiving of the audio visual medium of 604 can, in some embodiments, be in conjunction with receiving the educational matter in 602. The received audio visual medium can include a digital video disk (DVD), a video disk, a tape, a thumb-drive, a memory stick, and/or a webpage address having a login authorization, by way of example. The method continues with reviewing of the educational matter in 606, and displaying the lectures stored on the audio visual medium in 608. The displaying of the lectures shown in 608 can be in lieu of the student attending lectures that are presented to students in a classroom, which are often only given at well-defined times and locations. The displaying of the lectures in 608 that are stored on the audio visual medium can include, in some embodiments, displaying a required set of lectures associated with an educational course offered by the educational institution. In this case, the reviewing and displaying of the required set of lectures would be associated with the student completing a required set of course work for receiving a grade or for attending or taking a test, or receiving credit for the enrolled course.

In some embodiments of the invention, the receiving of educational matter and receiving the audio visual medium may be in association with the students registering for the educational course that is associated with the educational content of the educational matter. In some cases, the educational matter can include text and images and can be formatted in a variety of formats, such as a book, a magazine, a newspaper, loose leaf pages, and a web page.

As described herein, by way of the various exemplary embodiments, the invention, or embodiments thereof, can provide some or all various benefits to educational institutions, instructors, and students. These can include improved flexibility in delivering the educational experience to students without requiring the educational institution to allocate classroom resources to the student or having the student attend class to receive the educational experience. Additionally, the current systems and methods provide students with the ability and flexibility in viewing lectures when they are not able to attend the classroom or need to review a previously presented and viewed lecture. For instance, this could include period of illness, a refresher for the student, a reinforcement of the lecture, or a review of the lecture that may be required due to the inability of the student to hear or attentively view the lecture. This can also result in the increased availability of education to students who may not otherwise have an opportunity to receive an equivalent education. Other embodiments of the present invention are also available, as known to those skilled in the art, but are not separately identified herein.

When describing elements or features of the present invention or embodiments thereof, the articles “a”, “an”, “the”, and “said” are intended to mean that there are one or more of the elements or features. The terms “comprising”, “including”, “containing”, and “having” are intended to be inclusive and mean that there may be additional elements or features beyond those specifically described.

Those skilled in the art will recognize that various changes can be made to the exemplary embodiments and implementations described above without departing from the scope of the invention. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A system for educational content delivery, the system comprising:
educational matter having organized content addressing an educational topic; and
an audio visual medium including one or more presentations having content generally associated with the educational matter content and generally coordinated, at least in part, with the organization of the educational matter content.

2. The system of claim 1 wherein the educational matter includes text and printed matter selected from the group consisting of a book, a magazine, a newspaper, loose leaf pages, and a web page.

3. The system of claim 1 wherein the audio visual medium is selected from the group consisting of a digital video disk (DVD), a video disk, a tape, a thumb-drive, a memory stick, a webpage address and login authorization.

4. The system of claim 1 wherein the audio visual medium content includes visual demonstrations coordinated with audio.

5. The system of claim 1 wherein the educational matter and the audio visual medium include course content about equivalent to the content of an educational course offered by an educational institution traditionally requiring a student to attend lectures to obtain the same course content.

6. The system of claim 1, further comprising an audio visual presentation device configured to extract and present the audio visual medium content including displaying the presentations.

7. The system of claim 6 wherein the audio visual presentation device includes a communication interface configured for communication over a communication network, wherein at least a part of the content of the audio visual medium is communicated to the audio visual presentation device over the communication interface.

8. The system of claim 6 wherein the audio visual presentation device includes one or more devices selected from the group consisting of a computer, a disk player, a tape player, a television, a personal data assistance, a personal media player, and a mobile phone having a display.

9. The system of claim 1 wherein the audio visual medium includes a prerecorded image including one or more of a tour, a demonstration, a text, a graph, a chart, an experiment, an example, an outline, an interview, a mockup, a model, a play, and a staged act.

10. The system of claim 1 wherein at least one of the presentations includes an instructional presentation of a leading instructor related, at least in part, to the educational matter content.

11. The system of claim 1 wherein the audio visual medium is configured to be delivered to a student in conjunction with the delivery of the educational matter.

12. The system of claim 11 wherein the audio visual medium and the educational matter are each configured to be delivered to the student in conjunction with registration of the student for a course addressing the content of the educational matter.

13. The system of claim 1, further comprising at least one of a study guide, a study plan, a course outline, and course instructions related to use of the audio visual medium and the educational matter.

14. The system of claim 1 wherein the system for educational content delivery is configured as an educational kit.

15. A method of delivering educational content to a student, the method comprising:
offering a course having educational content;
registering a student for the offered course;
delivering to the registered student educational matter including the educational content in an organized format; and
delivering to the registered student an audio visual medium having one or more presentations with content generally associated with the educational content and generally coordinated, at least in part, with the organized format of the educational content.

16. The method of claim 15 wherein the offered course is identified as a course not requiring the student to attend a traditional classroom to receive the required educational content.

17. The method of claim 15, further comprising:
preparing the educational matter including text associated with the educational content;
recording the presentations; and
preparing the audio visual medium having the recorded presentations.

18. The method of claim 15, further comprising preparing a sequence of prerecorded images including one or more of a tour, a demonstration, a text, a graph, a chart, an experiment, an example, an outline, an interview, a mockup, a model, a play, and a staged act.

19. A method of acquiring educational content by a student comprising:
registering with an educational institution for a course having educational content;
receiving educational matter including the educational content in an organized format from the educational institution;
receiving an audio visual medium having a plurality of presentations with content generally associated with the educational content and generally coordinated, at least in part, with the organized format of the educational content;
reviewing the educational matter; and
displaying the presentations contained on the audio visual medium.

20. The method of claim 19 wherein the receiving of the educational matter and the audio visual medium are a function of the registering.

21. A method of providing an educational kit to be offered to students by an educational institution as a course, the method comprising:
preparing educational matter having educational content;
recording one or more presentations associated with the educational matter; and
preparing an audio visual medium having the presentations.

22. The method of claim 21 wherein preparing the educational matter includes producing printed educational material.

23. The method of claim 21 wherein preparing the audio visual medium includes preparing at least one storage medium selected from the list consisting of a digital video disk (DVD), a video disk, a tape, a thumb-drive, a memory stick, and a webpage.

24. The method of claim 21, further comprising preparing a prerecorded image including one or more of a tour, a demonstration, text, a graph, a chart, an experiment, an example, an outline, an interview, a mockup, a model, a play, and a staged act.

25. The method of claim 21 wherein at least one of the presentations includes an instructional presentation of a leading instructor related, at least in part, to the educational content.

26. The method of claim 21 wherein the educational matter and the audio visual medium are prepared by a supplier, further comprising delivering the educational matter and the audio visual medium to the educational institution.

27. A method of learning comprising:
receiving educational matter having educational content from an educational institution;
receiving an audio visual medium having lectures associated with the educational content from the educational institution;
reviewing the educational matter; and
displaying the lectures on the audio visual medium in lieu of attending classroom held lectures or as a supplemental educational aid to the classroom held lectures.

28. The method of claim 27 wherein receiving the audio visual medium is in conjunction with receiving the educational matter.

29. The method of claim 27, further comprising registering for an educational course associated with the educational content of the educational matter, and then receiving the educational matter and receiving the audio visual medium.

30. The method of claim 27 wherein the educational matter includes text and printed matter selected from the group consisting of a book, a magazine, a newspaper, loose leaf pages, and a web page.

31. The method of claim 27 wherein the audio visual medium is selected from the group consisting of a digital video disk (DVD), a video disk, a tape, a thumb-drive, a memory stick, and a webpage address having a login authorization.

32. The method of claim 27 wherein displaying the lectures on the audio visual medium includes displaying a required set of lectures associated with an educational course offered by the educational institution.

33. The method of claim 27 wherein receiving the educational matter and the audio visual medium is at the time of registering for an education course associated with the educational content of the educational matter.
